(19) United States
(12) Patent Application Publication
(10) Pub. No.: US 2006/0077282 A1
(43) Pub. Date: Apr. 13, 2006

(54) Image capturing apparatus and portable communication apparatus

(75) Inventors: Toshihito Kido, Matsubara-shi (JP); Tsutomu Honda, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/196,966

(22) Filed: Aug. 4, 2005

(30) Foreign Application Priority Data
Oct. 7, 2004 (JP) 2004-294604

(51) Int. Cl. H04N 5/235

(52) U.S. Cl. 348/362

(57) ABSTRACT

An image capture controller causes a reset operation to be performed in order from a pixel “1” with the half depression of a shutter button 4 as the trigger, and when the reset operation of a pixel “12” is completed, causes the reset operation to be again performed in order from the pixel “1”. When the shutter button 4 is fully depressed at a time T=T3, the image capture controller causes the execution of the reset operation to be stopped at a pixel “4” the reset operation of which is completed at that point of time, opens the shutter for an exposure time Tp from a time T=T4, and then, causes the output operation to be performed, from a time T=T6, in order from a pixel “5” next to the pixel “4” the reset operation of which is completed at the reset operation stop time (time T=T3), that is, in the order of the pixel “5”, . . . , a pixel “12”, . . . , to the pixel “4”.

This application is based on applications No. 2004-294604 filed in Japan, the content of which is hereby incorporated by reference.

### BACKGROUND OF THE INVENTION

The present invention belongs to the technical field of image capturing apparatuses and portable communication apparatuses provided with an image sensor of a CMOS (complementary metal oxide semiconductor) type or a MOS (metal oxide semiconductor) type, and particularly, relates to the technology of driving the image sensor.

### DESCRIPTION OF THE RELATED ART

In recent years, an image sensor using a CMOS has been attracting attention as an image sensor mounted on digital cameras because it can achieve increase in pixel signal readout speed, reduction in power consumption and increase in integration degree and meets the requirements of the size, performance and the like for digital cameras compared to an image sensor using a CCD (charge coupled device). Hereinafter, an image sensor using a CMOS will be referred to as CMOS sensor.

In the CMOS sensor, as shown in FIG. 16, a plurality of pixels are arranged in a matrix, and each pixel is connected to a vertical signal line connected to a vertical scanning circuit, and to a horizontal signal line connected to a horizontal scanning circuit. Since the CMOS sensor has such a structure, it is possible to specify a given pixel from among the plurality of pixels through the horizontal signal line and the vertical signal line and take out the accumulated charge from the pixel by the vertical scanning circuit and the horizontal scanning circuit.

For the purpose of enhancing the performance of an image capturing apparatus provided with an image sensor of this type, for example, the following method of driving the image sensor (pixel signal reading method) has been proposed:

It is assumed that, as shown in FIG. 16, the image sensor has, for example, fifteen pixels arranged in three rows and five columns and the order of the operation to read out the charges accumulated at the pixels is the order from the upper pixel row to the lower pixel row and in the order from the left to the right in each pixel row. As shown in FIG. 17, assuming that an image capture instruction is provided at the time T=T100, all the pixels are caused to perform, in the above-mentioned order, a reset operation to discharge the charges having been accumulated at the pixels until that time, and in the order in which the pixels complete the reset operation, the charges for the captured image are taken out at the point of time when a preset exposure time Tp has elapsed from the time of completion (an output operation is performed). In FIG. 17, “1” and “15” correspond to the numerals “1” and “15” of the pixels denoted by numerals “1” and “15” in FIG. 16.

Moreover, a method is also known in which, in a case where the image capturing apparatus is provided with a mechanical shutter, the image sensor is driven in the following manner in conjunction with the operation of the shutter. FIG. 18 is a time chart showing this image sensor driving method.

As shown in FIG. 18, assuming that an image capture instruction is provided at the time T=T100, all the pixels are caused to perform the reset operation in the above-mentioned order. Then, after the reset operations of all the pixels are completed at the time T=T102, the shutter is opened at the time T=T103, the shutter is closed at the time T=T104 at which a preset exposure time has elapsed, and then, the charges for the captured image are taken out from all the pixels in the above-mentioned order from the time T=T105.

In addition to these image sensor driving methods, for example, the following image sensor driving method is known. FIG. 19 is a time chart showing this image sensor driving method.

Assuming that an image capture instruction is provided at the time T=T100, all the pixels are caused to perform the reset operation (“reset 1” operation in the figure) in the above-mentioned order. Then, after the reset operations of all the pixels are completed at the time T=T102, the charges for the captured image are taken out from the pixels at the point of time when a preset exposure time has elapsed.

Then, in order to remove the noise contained in the pixels signal obtained by the operation to take out the charges for the captured image, with respect to each pixel, the reset operation (“reset 2” operation in the figure) is again performed immediately after the operation to take out the charges for the captured image. Then, regarding the voltage of the pixel immediately after the “reset 2” operation as approximate to the voltage of the pixel immediately after the “reset operation 1,” instead of the processing to subtract the voltage of the pixel immediately after the “reset 1” operation from the voltage corresponding to the pixel signal (in order to avoid providing a storage for storing the voltage of the pixel immediately after the “rest 1” operation to perform this processing), the voltage of the pixel immediately after the “reset 2” operation is subtracted from the pixel signal, and the signal corresponding to the voltage which is the result of the subtraction is determined as the signal corresponding to the captured image.

However, the following problems arise in the above-described image sensor driving methods:

In the driving methods shown in FIGS. 16 and 17, the exposure start timing varies among the pixels. For this reason, a subject that is shifted in time is present in one captured image obtained by the output operations of the pixels, so that the possibility is high that the obtained image deviates from the subject image intended by the user or is an image with a sense of difference. This is a significant problem particularly when the subject is a moving object.

On the other hand, in the method as shown in FIG. 18 driving the image sensor in conjunction with the operation of the shutter, since the pixels simultaneously start the exposure operation by the shutter opening operation, it never occurs that a subject that is shifted in time is present in one captured image obtained by the output operations of the pixels.

However, in this method, when an image capture instruction is provided, after all the reset operations are performed, the exposure operation of the image sensor is performed, so that the time difference between the timing of the provision of the image capture instruction and the timing of the actual capturing of the subject image to record is comparatively large and there is a possibility that the obtained image deviates from the subject image intended by the user.

In the driving method shown in FIG. 19, since the exposure start timing varies among the pixels, a similar problem to that of the method of FIG. 17 arises. In addition, the object subtracted from the pixel signal obtained by the output operations of the pixels for noise removal is the signal (charge) obtained by the “reset 2” operation performed immediately after the operation to take out the pixel signal. Although this signal is regarded as approximate to the charge remaining at the pixel immediately after the “reset 1” operation which charge is originally to be subtracted from the pixel signal, since there is a possibility that this signal is not strictly the same, it is difficult to say that the noise can be accurately removed from the pixel signal obtained by the output operation.

### SUMMARY OF THE INVENTION

The present invention is made in view of the above-mentioned circumstances, and an object thereof is to provide an image capturing apparatus and a portable communication apparatus capable of obtaining a captured image that is as close to the subject image intended by the user as possible and is low in noise.

To attain the above-mentioned object, according to a first aspect of the present invention, an image capturing apparatus is provided with: an image sensor comprising a plurality of pixels aligned in two intersecting directions; an image capture controller that causes the image sensor to perform an exposure operation, specifies a given pixel from among the plurality of pixels, and causes the specified pixel to output a pixel signal; and an input operation portion for inputting an instruction to cause the image sensor to generate a pixel signal for recording to be recorded in a predetermined recording portion. Until the instruction to generate the pixel signal for recording is inputted through the input operation portion, the image capture controller causes the image sensor to repeat a reset operation of the pixels in a predetermined order and when the generation instruction is inputted through the input operation portion, the image capture controller causes the image sensor to stop the reset operation irrespective of a position of the order of the pixel the reset operation of which is completed.

Thus, until the instruction to generate the pixel signal for recording is inputted through the input operation portion, the reset operation of the pixels by the image sensor is repeated in the predetermined order, and when the generation instruction is inputted through the input operation portion, the reset operation by the image sensor is stopped irrespective of the order of the pixel the reset operation of which is completed.

By this, the exposure operation for obtaining the pixel signal for recording by the image sensor can be performed at a timing close to the timing of the generation instruction compared to the prior art in which after the instruction to generate the pixel signal for recording is inputted through the input operation portion, the image sensor is caused to perform the reset operations of all the pixels.

Consequently, a captured image with little noise which image is as close to the subject image intended by the user as possible can be obtained.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 showing an embodiment of the present invention is a front view of a digital camera;

FIG. 2 is a rear view showing the structure of the digital camera;

FIG. 3 is a view showing the internal structure of the digital camera;

FIG. 4 is a block diagram showing the electric structure of the entire digital camera in a condition where the taking lens system is attached to the camera body;

FIG. 5 is a view showing the schematic structure of an image sensor;

FIG. 6 a view schematically representing the pixel arrangement of the image sensor;

FIG. 7A is a time chart for explaining the operations of the pixels of the image sensor in a first embodiment;

FIG. 7B is a time chart for explaining the operations of the pixels of a conventional image sensor;

FIGS. 8A to 8E are views for explaining an interpolation processing;

FIG. 9 is a flowchart showing a processing by a main controller;

FIG. 10 is a time chart showing the operations of the pixels of the image sensor in a first modification;

FIG. 11A is a time chart showing the operations of the pixels of the image sensor in a case where the image capturing apparatus is provided with no shutter and the aperture value is fixed;

FIG. 11B is a time chart for explaining the operations of the pixels of the image sensor in the conventional structure;

FIG. 12 is a time chart showing the operations of the pixels of the image sensor in a case where the aperture value is set as the control parameter of the exposure value of the image sensor;

FIG. 13 is a view for explaining a method of dividing the pixels of the image sensor into groups;

FIG. 14 is a view for explaining another method of dividing the pixels of the image sensor into groups;

FIG. 15 is a time chart showing a driving control of the image sensor for generating and displaying a live view image;

FIG. 16 is a view for explaining the prior art;

FIG. 17 is a view for explaining the prior art;

FIG. 18 is a view for explaining the prior art; and

FIG. 19 is a view for explaining the prior art.

### DETAILED DESCRIPTION OF THE PREFERRED EMBODIMENTS

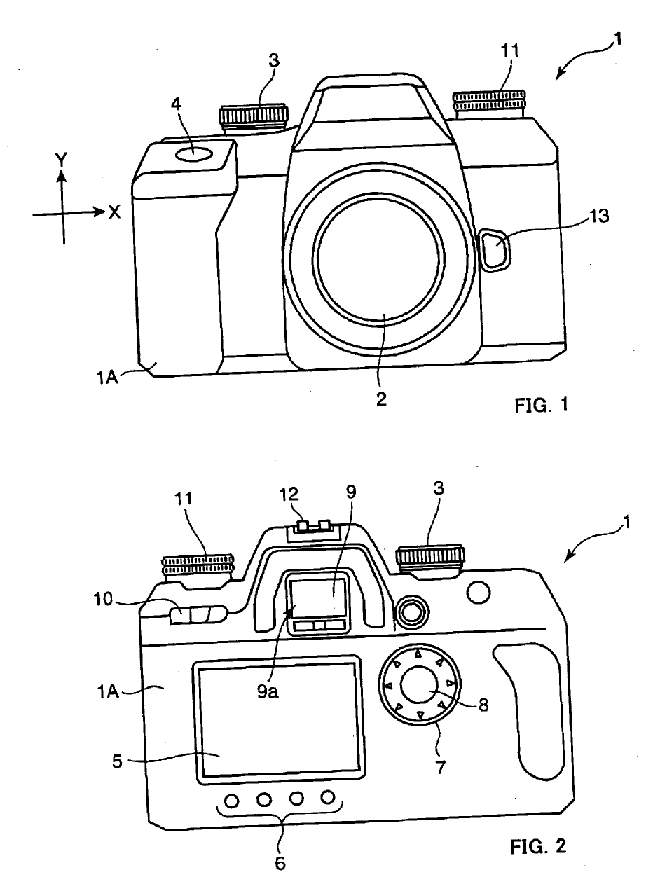

A first embodiment of the present invention will be described. First, the external and internal structures of a digital camera which is an example of the image capturing apparatus will be described with reference to FIGS. 1 to 3.

As shown in FIGS. 1 and 2, a digital camera 1 of the present embodiment is a single lens reflex camera in which a taking lens system (interchangeable lens) 2 is interchangeably (detachably) attached to a box-shaped camera body 1A. The digital camera 1 is provided with: the taking lens system 2 attached substantially to the center of the front surface of the camera body 1A; a first mode setting dial 3 disposed in an appropriate position on the top surface; a shutter start button 4 disposed on an upper corner; an LCD (liquid crystal display) 5 disposed on the left side of the back surface; setting buttons 6 disposed below the LCD 5; a ring-shaped operation portion 7 disposed on a side of the LCD 5; a push button 8 disposed inside the ring-shaped operation portion 7; an optical viewfinder 9 disposed above the LCD 5; a main switch 10 disposed on a side of the optical viewfinder 9; a second mode setting dial 11 disposed in the vicinity of the main switch 10; and a connection terminal 12 disposed above the optical viewfinder 9.

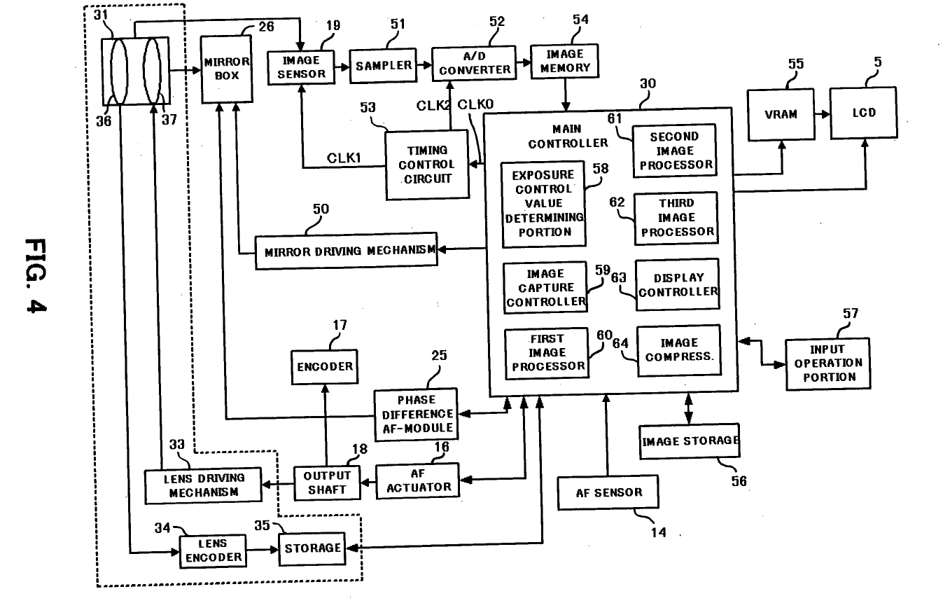

The taking lens system 2 comprises a plurality of lens elements, which are optical elements, arranged in a direction vertical to the plane of FIG. 1 within a lens barrel. As optical elements incorporated in the taking lens system 2, a zoom lens unit 36 for performing zooming (see FIG. 4) and a focusing lens unit 37 for performing focusing (see FIG. 4) are provided. By these lens units being driven in the direction of the optical axis, zooming and focusing are performed, respectively.

The taking lens system 2 of the present embodiment is a manual zoom lens system in which an operation ring (not shown) that is rotatable along the outer circumference of the lens barrel is provided in an appropriate position on the outer surface of the lens barrel. The zoom lens unit 36 moves in the direction of the optical axis in accordance with the rotation direction and rotation amount of the operation ring, and the zoom magnification of the taking lens system 2 is determined in accordance with the position to which the zoom lens unit 36 is moved. The taking lens system 2 can be detached from the camera body 1A by rotating the taking lens system 2 while depressing a lens release button 13.

The first mode setting dial 3 is a substantially disc-like member that is rotatable within a plane substantially parallel to the top surface of the digital camera 1, and is provided for alternatively selecting a mode or a function provided for the digital camera 1 such as a recording mode for taking a still image or a moving image and a playback mode for playing back a recorded image. Although not shown, on the top surface of the first mode setting dial 3, characters representative of the functions are printed at predetermined intervals along the circumference, and the function corresponding to the character set at the position opposed to the index provided in an appropriate position on the side of the camera body 1A is executed.

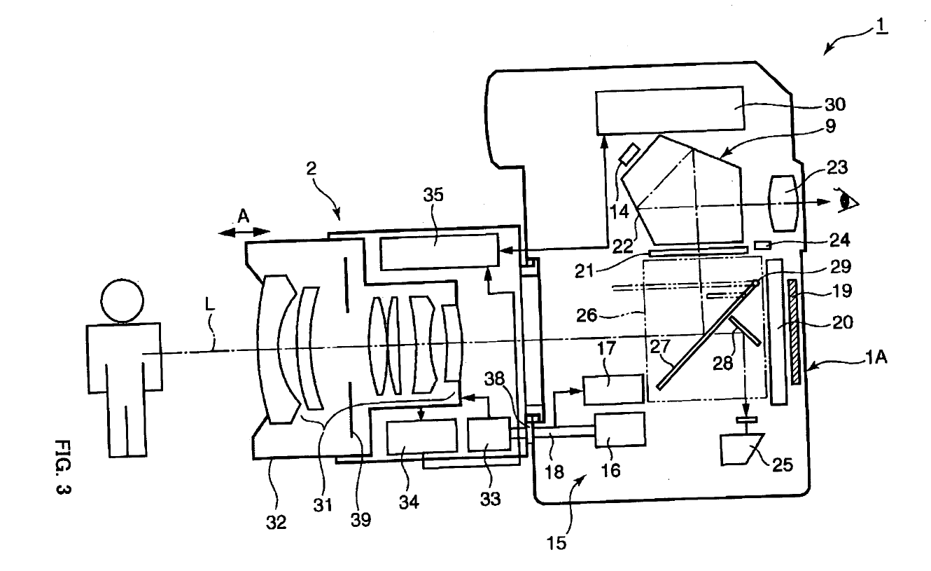

The shutter start button 4 is depressed in two steps of being half depressed and being fully depressed, and is provided mainly for specifying the timing of an exposure operation by an image sensor 19 described later (see FIGS. 3 and 4). By the shutter start button 4 being half depressed, the digital camera 1 is set in an exposure standby state in which the setting of exposure control values (the shutter speed and the aperture value) and the like is performed by use of a detection signal of an AE sensor 14 described later (see FIG. 3), and by the shutter start button 4 being fully depressed, the exposure operation by the image sensor 19 for generating a subject image to be recorded in an image storage 56 described later (see FIG. 4) is started. In order to simplify the explanation of the function, the present embodiment is explained on the assumption that the aperture value is fixed.

The half depression of the shutter start button 4 is detected by a non-illustrated switch S1 being turned on, and the full depression of the shutter start button 4 is detected by a non-illustrated switch S2 being turned on.

The LCD 5 which has a color liquid crystal panel performs the display of an image captured by the image sensor 19 and the playback of an recorded image, and displays a screen for setting functions and modes provided for the digital camera 1. Instead of the LCD 5, an organic EL display or a plasma display may be used.

The setting buttons 6 are provided for performing operations associated with various functions provided for the digital camera 1.

The ring-shaped operation portion 7 has an annular member having a plurality of depression parts (the triangular parts in the figure) arranged at predetermined intervals in the circumferential direction, and is structured so that the depression of each depression part is detected by a non-illustrated contact (switch) provided so as to correspond to each depression part. The push button 8 is disposed in the center of the ring-shaped operation portion 7. The ring-shaped operation portion 7 and the push button 8 are provided for inputting instructions for the frame advance of the recorded image played back on the LCD 5, the setting of the position to be in focus in the field of view and the setting of the exposure conditions (the aperture value, the shutter speed, the presence or absence of flash emission, etc.).

The optical viewfinder 9 is provided for optically showing the field of view. The main switch 10 is a two-position slide switch that slides horizontally. When the main switch 10 is set at the left position, the main power of the digital camera 1 is turned on, and when it is set at the right position, the main power is turned off.

The second mode setting dial 11 has a similar mechanical structure to the first mode setting dial 3, and is provided for performing operations associated with various functions provided for the digital camera 1. The connection terminal 12 which is disposed in an accessory shoe is provided for connecting an external device such as a non-illustrated electronic flash device to the digital camera 1.

As shown in FIG. 3, the following are provided in the camera body 1A: an AF driving unit 15; the image sensor 19; a shutter unit 20; the optical viewfinder 9; a phase difference AF module 25; a mirror box 26; the AE sensor 14; and a main controller 30.

The AF driving unit 15 is provided with an AF actuator 16, an encoder 17 and an output shaft 18. The AF actuator 16 includes a motor generating a driving force such as a DC motor, a stepping motor or an ultrasonic motor and a non-illustrated reduction system for transmitting the rotational force of the motor to the output shaft with reducing the rotational speed.

Although not described in detail, the encoder 17 is provided for detecting the rotation amount transmitted from the AF actuator 16 to the output shaft 18. The detected rotation amount is used for calculating the position of the focusing lens unit 37 in the taking lens system 2. The output shaft 18 is provided for transmitting the driving force outputted from the AF actuator 16, to a lens driving mechanism 33 in the taking lens system 2.

The image sensor 19 is disposed substantially parallel to the back surface of the camera body 1A in a back surface side area of the camera body 1A. The image sensor 19 is, for example, a CMOS color area sensor of a Bayer arrangement in which a plurality of photoelectric conversion elements each comprising a photodiode or the like are two-dimensionally arranged in a matrix and color filters of, for example, R (red), G (green) and B (blue) having different spectral characteristics are disposed at a ratio of 1:2:1 in a Bayer arrangement on the light receiving surfaces of the photoelectric conversion elements. The image sensor 19 converts the light image of the subject formed by an image capturing optical system 31 into analog electric signals (image signals) of color components R (red), G (green) and B (blue), and outputs them as image signals of R, G and B.

The shutter unit 20 comprises a focal plane shutter (hereinafter, referred merely to shutter), and is disposed between the back surface of the mirror box 26 and the image sensor 19.

The optical viewfinder 9 is disposed above the mirror box 26 disposed substantially in the center of the camera body 1A, and comprises a focusing screen 21, a prism 22, an eyepiece lens 23 and a finder display element 24. The prism 22 is provided for horizontally reversing the image on the focusing screen 21 and directing it to the user's eye through the eyepiece lens 23 so that the subject image can be viewed. The finder display element 24 displays the shutter speed, the aperture value, the exposure compensation value and the like in a lower part of a display screen formed within a finder field frame 9a (see FIG. 2).

The phase difference AF module 25 is disposed below the mirror box 26, and is provided for detecting the focus condition by a known phase difference detection method. The phase difference AF module 25 has a structure disclosed, for example, in U.S. Pat. No. 5,974,271, and a detailed description of the structure is omitted.

The mirror box 26 is provided with a quick return mirror 27 and a sub mirror 28. The quick return mirror 27 is structured so as to be pivotable about a pivot axis 29 between a position inclined substantially 45° with respect to the optical axis L of the image capturing optical system 31 as shown by the solid line of FIG. 3 (hereinafter, referred to as inclined position) and a position substantially parallel to the bottom surface of the camera body 1A as shown by the virtual line of FIG. 3 (hereinafter, referred to as horizontal position).

The sub mirror 28 is disposed on the back surface side of the quick return mirror 27 (the side of the image sensor 19), and is structured so as to be displaceable in conjunction with the quick return mirror 27 between a position inclined substantially 90° with respect to the quick return mirror 27 in the inclined position as shown by the solid line of FIG. 3 (hereinafter, referred to as inclined position) and a position substantially parallel to the quick return mirror 27 in the horizontal position as shown by the virtual line of FIG. 3 (hereinafter, referred to as horizontal position). The quick return mirror 27 and the sub mirror 28 are driven by a mirror driving mechanism 50 described later (see FIG. 4).

When the quick return mirror 27 and the sub mirror 28 are in the inclined position (the period to the time the shutter start button 4 is fully depressed), the quick return mirror 27 reflects most of the luminous flux by the lenses 31 in the taking lens system 2 toward the focusing screen 21 and transmits the remaining luminous flux, and the sub mirror 28 directs the luminous flux transmitted through the quick return mirror 27 to the phase difference AF module 25. At this time, the display of the subject image by the optical viewfinder 9 and the focus detection according to the phase difference detection method by the phase difference AF module 25 are performed, whereas the display of the subject image by the LCD 5 is not performed because no luminous flux is directed to the image sensor 19.

On the other hand, when the quick return mirror 27 and the sub mirror 28 are in the horizontal position (when the shutter start button 4 is fully depressed), since the quick return mirror 27 and the sub mirror 28 are retracted from the optical axis L and the shutter unit 20 opens the optical path, substantially all the luminous flux transmitted by the lenses 31 is directed to the image sensor 19. At this time, the display of the subject image by the LCD 5 is performed, whereas the display of the subject image by the optical viewfinder 9 and the focusing operation according to the phase difference detection method by the phase difference AF module 25 are not performed.

The AE sensor 14 comprises an image sensor that captures a light image of the subject formed on the focusing screen 21 through the lens, and is provided for detecting the brightness of the subject.

The main controller 30 comprises, for example, a microcomputer incorporating a storage such as a ROM storing a control program and a flash memory temporarily storing data. A detailed function thereof will be described later.

Next, the taking lens system 2 attached to the camera body 1A will be described.

As shown in FIG. 3, the taking lens system 2 comprises the lenses 31, lens barrels 32, the lens driving mechanism 33, an encoder 34 and a storage 35.

In the lenses 31, elements including the zoom lens unit 36 for changing the image magnification (focal length) (see FIG. 4), the focusing lens unit 37 for adjusting the focus condition (see FIG. 4) and a diaphragm 39 for adjusting the quantity of light incident on the image sensor 19 described later or the like provided in the camera body 1A are held so as to be aligned in the direction of the optical axis L. The lenses 31 introduces the luminous flux from the subject and forms the luminous flux into an image on the image sensor 19 or the like. The focusing operation is performed by the focusing lens unit 37 being driven in the direction of the optical axis L by the AF actuator 16 in the camera body 1A. The change of the image magnification (focal length), that is, zooming is manually performed with a non-illustrated zoom ring.

The lens driving mechanism 33 comprises, for example, a helicoid and a non-illustrated gear or the like that rotates the helicoid, and moves the focusing lens unit 37 in the direction of the arrow A parallel to the optical axis L by receiving the driving force from the AF actuator 16 through a coupler 38. The movement direction and the movement amount of the focusing lens unit 37 are responsive to the rotation direction and the number of rotations of the AF actuator 16, respectively.

The lens encoder 34 comprises: an encoding plate where a plurality of code patterns are formed with predetermined pitches in the direction of the optical axis L within the movement range of the focusing lens unit 37; and an encoder brush that moves integrally with the focusing lens unit 37 while sliding on the encoding plate, and is provided for detecting the movement amount at the time of focusing of the focusing lens unit 37.

The storage 35 provides the main controller 30 in the camera body 1A with the stored contents when the taking lens system 2 is attached to the camera body 1A and the main controller 30 in the camera body 1A makes a request for data. The storage 35 stores information on the movement amount of the focusing lens unit 37 and the like outputted from the lens encoder 34.

Next, the electric structure of the digital camera 1 of the present embodiment will be described with reference to FIG. 4. The members within the dotted enclosure of FIG. 4 are provided in the taking lens system 2. While FIG. 4 shows the members in blocks according to the functions for the sake of convenience, this does not mean only that each function is attained by an independent structure but includes ones associated with one another, overlapping one another and attained by software.

Since the mechanical structure of the digital camera 1 and the taking lens system 2, that is, the lenses 31, the lens driving mechanism 33, the lens encoder 34, the storage 35 and the mirror box 26 are described in the above, redundant explanation is omitted here.

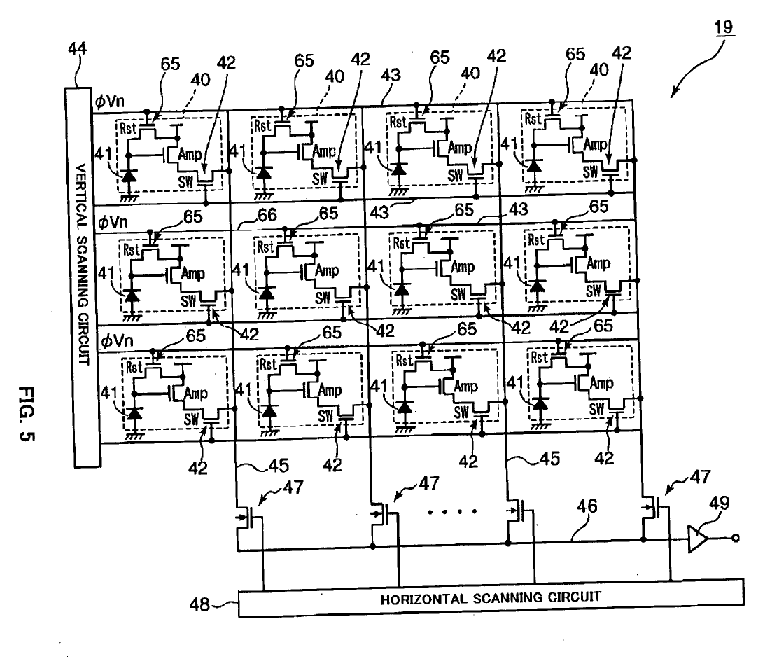

With reference to FIG. 5, the image sensor 19 will be described in detail.

As shown in FIG. 5, the image sensor 19 comprises a plurality of pixels 40 arranged in a matrix. The pixels 40 each comprise a photodiode 41 performing photoelectric conversion and a vertical selecting switch 42 for selecting the pixel 40 to output a pixel signal. The image sensor 19 is provided with: a vertical scanning circuit 44 that outputs a vertical scanning pulse φVn to vertical scanning lines 43 to which the control electrodes of the vertical selecting switches 42 are connected in common in each row of the matrix of the pixels 40; horizontal scanning lines 45 to which the main electrodes of the vertical selecting switches 42 are connected in common in each column; horizontal switches 47 connected to the horizontal scanning lines 45 and a horizontal signal line 46; a horizontal scanning circuit 48 connected to the control electrodes of the horizontal switches 47; and an amplifier 49 connected to the horizontal signal line 46.

The pixels 40 are each provided with a reset switch 65. The image sensor 19 has a reset line 66 to which the reset switches 65 of the pixels 40 are connected in common.

In the image sensor 19 having such a structure, by outputting the charges accumulated at the pixels pixel by pixel and controlling the operations of the vertical scanning circuit 44 and the horizontal scanning circuit 48, it is possible to specify a pixel and cause the pixel to output the charge. That is, by the vertical scanning circuit 44, the charge that is reset or photoelectrically converted by the photodiode 41 of a given pixel is outputted to the horizontal scanning line 45 through the vertical selection switch 42 or outputted to the reset line through the reset switch 65, and then, by the horizontal scanning circuit 48, the charge outputted to the horizontal scanning line 45 or the like is outputted to the horizontal signal line 46 through the horizontal switch 47. By successively performing this operation with respect to each pixel, it is possible to cause all the pixels to output the charges in order while specifying a pixel. The charges outputted to the horizontal signal line 46 are converted into voltages by the amplifier 49 connected to the horizontal signal line 46.

In the image sensor 19 having such a structure, image capturing operations such as the start and end of the exposure operation of the image sensor 19 and the readout of the output signals of the pixels of the image sensor 19 (horizontal synchronization, vertical synchronization, and transfer) are controlled by a timing control circuit 53 described later.

Returning to FIG. 4, a mirror driving mechanism 50 drives the quick return mirror 27 and a sub mirror 28 between the inclined position and the horizontal position, and is controlled by the main controller 30.

A sampler 51 samples the analog pixel signal outputted from the image sensor 19, and reduces the noise (noise different from a reset noise described later) of the pixel signal.

The A/D converter 52 converts the analog pixel signals of R, G and B outputted by the sampler 51 into digital pixel signals comprising a plurality of bits (for example, 10 bits). Hereinafter, the pixel signals having undergone the A/D conversion by the A/D converter 52 will be referred to as image data so that they are distinguished from the analog pixel signals.

The timing control circuit 53 controls the operations of the image sensor 19 and the A/D converter 52 by generating clocks CLK1 and CLK2 based on a reference clock CLK0 outputted from the main controller 30 and outputting the clock CLK1 to the image sensor 19 and the clock CLK2 to the A/D converter 52.

An image memory 54 is a memory that, in the recording mode, temporarily stores the image data outputted from the A/D converter 52 and is used as the work area for performing a processing described later on the image data by the main controller 30. In the playback mode, the image memory 54 temporarily stores the image data read out from the image storage 56 described later.

A VRAM 55 which has an image signal storage capacity corresponding to the number of pixels of the LCD 5 is a buffer memory for the pixel signals constituting the image played back on the LCD 5. The LCD 5 corresponds to the LCD 5 of FIG. 2.

The image storage 56 comprises a memory card or a hard disk, and stores the images generated by the main controller 30.

An input operation portion 57 includes the first mode setting dial 3, the shutter start button 4, the setting buttons 6, the ring-shaped operation portion 7, the push button 8, the main switch 10 and the second mode setting dial 11, and is provided for inputting operation information to the main controller 30.

The main controller 30 controls the drivings of the members in the digital camera 1 shown in FIG. 4 so as to be associated with one another. Moreover, as shown in FIG. 4, the main controller 30 is functionally provided with an exposure control value determiner 58, an image capture controller 59, a first image processor 60, a second image processor 61, a third image processor 62, a display controller 63 and an image compressor 64.

The exposure control value determiner 58 determines the exposure control values for the exposure operation for recording is performed, based on the detection signal (the brightness of the subject) from the AE sensor 14. In the present embodiment, since the aperture value is fixed, the exposure time corresponding to the shutter speed is determined by the exposure control value determiner 58.

When the shutter start button 4 is half depressed by the user, the image capture controller 59 causes the pixels of the image sensor 19 to repeat the operation to output the accumulated charges (hereinafter, referred to as reset operation) at predetermined intervals. Generally, the “reset operation” performed by the image sensor 19 includes: an operation to merely discard (discharge) the charges accumulated at the pixels, within the image sensor 19; an operation to output the charges accumulated at the pixels, to detect a reset voltage described later; and an operation to output the charges accumulated at the pixels to the outside (the sampler 51, etc.) to use them for a predetermined purpose. In the present embodiment, the “reset operation” means the operation to output the charges accumulated at the pixels, to detect the reset voltage.

When the shutter start button 4 is fully depressed, the image capture controller 59 causes the pixels to output the accumulated charges to generate pixel signals for recording, and controls the opening and closing of the shutter unit 20.

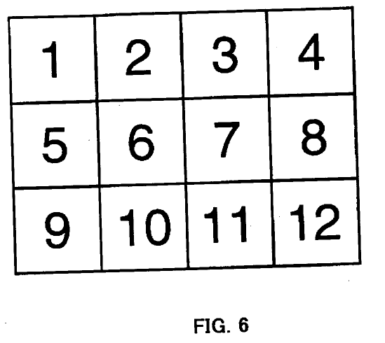

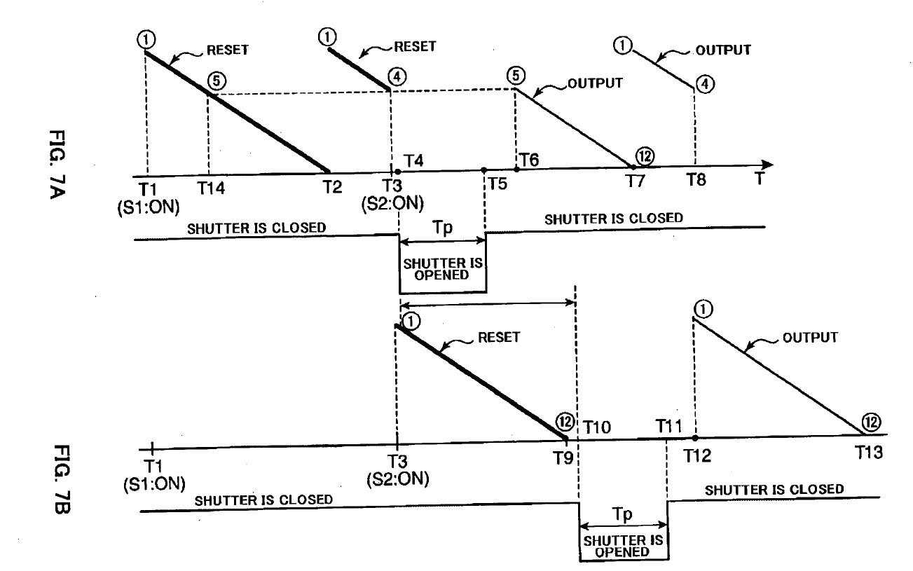

The present embodiment features the driving control of the image sensor 19 by the image capture controller 59 performed when the shutter start button 4 is half depressed and fully depressed. The contents thereof will be described in detail with reference to FIGS. 6, 7A and 7B. The frames in FIG. 6 represent pixels. In FIGS. 7A and 7B, the horizontal axis represents time.

It is assumed that as shown in FIG. 6, the image sensor 19 has twelve pixels arranged in three rows and four columns and the operation to take out the accumulated charges from the pixels is performed in the order of the numerals assigned to the pixels (frames) in the figure. That is, the operation to output the accumulated charges from the pixels (the reset operation and the output operation for generating pixels signals for recording) is performed in the order from the upper to lower pixel rows and in each pixel row, in the order from the left to the right.

In the present embodiment, when the shutter start button 4 is half depressed, the image capture controller 59 causes the image sensor 19 to start the reset operation of the pixels. This reset operation is repeated in the above-mentioned order until the shutter start button 4 is fully depressed.

That is, as shown in FIGS. 6 and 7A, when the shutter start button 4 is half depressed at the time T=T1, the image capture controller 59 causes the reset operation to be performed from the pixel “1”, and when the reset operation of the pixel “12” is completed (the time T=T2), causes the reset operation to be again performed from the pixel “1”. The numerals “1”, “4”, “5” and “12” in FIG. 7A correspond to the numerals assigned to the pixels shown in FIG. 6.

When the shutter start button 4 is fully depressed, the image capture controller 59 causes the image sensor 19 to stop the execution of the reset operation at the pixel the reset operation of which is completed at that point of time, open the shutter based on the exposure control values set by the exposure control value determiner 58 during the exposure preparation period (the period from the time the shutter start button 4 is half depressed to the time it is fully depressed), and after the shutter is closed, perform the operation to output the accumulated charges (corresponding to the above-mentioned pixel signals for recording) for recording into the image storage 56 from the pixel next to the pixel on which the reset operation is performed last.

That is, as shown in FIGS. 6 and 7A, when the shutter start button 4 is fully depressed at the time T=T3, the image capture controller 59 opens the shutter immediately. FIG. 7A indicates that the shutter is opened at the time T=T4 at which a slight time has elapsed from the time T=T3.

Then, the image capture controller 59 opens the shutter for the exposure time Tp (from the time T=T4 to the time T=T5) set by the exposure control value determiner 58, and causes the output operation for generating pixel signals for recording to be performed from the time T=T6 at which a predetermined time has elapsed from the time T=T5 at which the shutter is closed. In that case, assuming that the reset operation of the pixel “4” has been completed at the time when the reset operation is stopped (the time T=T3), the output operation for generating pixel signals for recording is performed in order from the next pixel “5”. That is, the output operation for generating pixel signals for recording is performed in the order of the pixel “5”, . . . , the pixel “12”, the pixel “1”, . . . to the pixel “4”.

By thus causing the image sensor 19 to perform the reset operation of the pixels in order from the time the shutter start button 4 is half depressed to the time it is fully depressed, and when the shutter start button 4 is fully depressed, stop the execution of the reset operation at the pixel the reset operation of which is completed at that point of time and perform the output operation for generating pixel signals for recording in order from the pixel next to the pixel on which the reset operation is performed last, as described below, the shutter operation time lag can be reduced compared to the conventional structure performing the reset operations of all the pixels after the shutter start button 4 is fully depressed.

As shown in FIG. 7B, in the conventional structure, when the shutter start button 4 is fully depressed at the time T=T3, the reset operation is performed in order from the pixel “1”, and at the time T=T10 at which a slight time has elapsed from the time T=T9 at which the reset operation of the pixel “12” is completed, the control to open the shutter is performed. The time from the time T=T3 to the time T=T9 is the same as the time from the time T=T1 to the time T=T2.

Then, the shutter is opened for the exposure time Tp (from the time T=T10 to the time T=T11) set during the exposure preparation period, and from the time T=T12 at which a predetermined time has elapsed from the time T=T11 at which the shutter is closed, the output operation for generating pixel signals for recording is performed in order from the pixel “1”.

As described above, in the conventional structure, the timing to open the shutter (to cause the image sensor 19 to start the exposure operation to generate pixel signals for recording) is the time T=T10, whereas in the present embodiment, the timing to open the shutter can be the time T=T4 closer to the time T=T3 than the time T=T10 because the reset operations of all the pixels are not newly performed in response to the full depression of the shutter start button 4.

That is, the time difference between the timing of the full depression of the shutter start button 4 and the timing of the start of the exposure operation for recording by the image sensor 19, that is, the shutter operation time lag can be reduced compared to the conventional structure. Consequently, according to the present embodiment, an image as close to the subject image at the point of time when the user fully depresses the shutter start button 4 (the image capturing timing intended by the user) as possible can be obtained.

The start timing of the operation to output pixel signals for recording (the time T=T6) is set in consideration of a time error of the shutter operation (closing operation).

Even though the image sensor 19 performs the reset operation, the voltages of the pixels immediately after the reset operation are not 0 V in many cases. Since the voltages do not constitute an image for recording, that is, the voltage are noise, by subtracting the voltage of the pixel immediately after the reset operation from the voltage corresponding to the image data obtained by the output operation for generating pixel signals for recording with respect to each pixel, an image more faithful to the subject image can be obtained compared to the case where merely the pixel data obtained by the output operation for generating pixel signals for recording itself is used as the pixel data for recording of the pixels.

Accordingly, according to the present embodiment, a noise removal processing is performed to subtract the voltage of each pixel immediately after the reset operation (hereinafter, referred to as reset voltage) from the voltage corresponding to the pixel data obtained by the output operation for generating pixel signals for recording with respect to each pixel.

In that case, according to the present embodiment, to perform the noise removal processing, the voltages of the pixels immediately after the reset operation are updated and stored one by one with respect to each pixel, and when the shutter start button 4 is fully depressed, with respect to each pixel, the stored voltage of the pixel immediately after the reset operation is subtracted from the voltage corresponding to the pixel data obtained by the output operation for generating pixel signals for recording. By this, the processing can be performed irrespective of the timing of the full depression of the shutter start button 4.

The first image processor 60 which performs such a noise removal processing updates and stores into the image memory 54 the voltages of the pixels immediately after the reset operation started by the half depression of the shutter start button 4 with respect to each pixel, and when the pixel data is obtained from each pixel by the output operation for generating pixel signals for recording performed after the full depression of the shutter start button 4, with respect to each pixel, subtracts the latest reset voltage of the pixel stored in the image memory 54 from the output voltage corresponding to the obtained pixel data, thereby performing the noise removal processing.

Describing the processing by the first image processor 60 with reference to FIG. 7A, for example, with respect to the pixel “5”, the output operation for generating pixel signals for recording is performed at the time T=T6, and from the accumulated charge obtained by the output operation, the pixel data is obtained through the processing by the sampler 51 and the A/D converter 52. On the other hand, the latest reset operation by the pixel “5” is the reset operation performed at the time T=T14, and the reset voltage of the pixel immediately after the reset operation is stored in the image memory 54 at the time T=T6. Therefore, the first image processor 60 reads out the reset voltage from the image memory 54, and subtracts the reset voltage of the pixel “5” read out from the image memory 54 from the output voltage corresponding to the pixel data obtained by the output operation for generating pixel signals for recording.

This also applies, for example, to the pixel “4”. The output operation for generating pixel signals for recording is performed at the time T=T8, and from the accumulated charge obtained by the output operation, the pixel data is obtained through the processing by the sampler 51 and the A/D converter 52. On the other hand, the latest reset operation by the pixel “4” is the reset operation performed at the time T=T3, and the reset voltage of the pixel immediately after the reset operation is stored in the image memory 54 at the time T=T8. Therefore, the first image processor 60 reads out the reset voltage from the image memory 54, and subtracts the reset voltage corresponding to the pixel “4” read out from the image memory 54 from the output voltage corresponding to the pixel data obtained by the output operation for generating pixel signals for recording.

After performing the above-described noise removal processing with respect to each pixel, the first image processor 60 stores the pixel data having undergone the processing into the image memory 54.

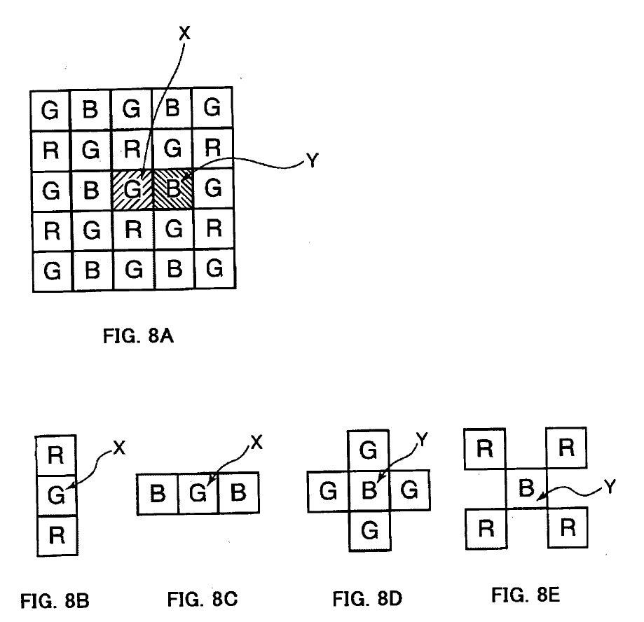

The second image processor 61 performs an interpolation processing to obtain the pixel data of the color components of R (red), G (green) and B (blue) at the positions of the pixels based on the noise-removed pixel data stored in the image memory 54. This interpolation processing will be described with reference to FIGS. 8A to 8E.

That is, since color filters of, for example, R (red), G (green) and B (blue) having different spectral characteristics are disposed at a ratio of 1:2:1 on the light receiving surfaces of the photoelectric conversion elements in the image sensor 19 of the present embodiment, only the pixel data of R (red) is obtained from the pixels where color filters of R (red) are disposed, only the pixel data of G (green) is obtained from the pixels where color filters of G (green) are disposed, and only the pixel data of B (blue) is obtained from the pixels where color filters of B (blue) are disposed.

Therefore, to obtain the pixel data of the color components of R (red), G (green) and B (blue) at all positions of the pixels, the second image processor 61 calculates the pixel data of the color component that is absent at the position of the pixel by use of the pixel data of the pixels situated around the pixel.

Specifically, as shown in FIG. 8A, for example, with respect to the position of the pixel indicated by the arrow X, the pixel data of G (green) is obtained from the pixel, and pixel data of R (red) and B (blue) are absent. Therefore, the absent pixel data of R (red) is calculated by use of the pixel data of, of the pixels situated around the pixel, the pixels where color filters of R (red) are disposed, and the absent pixel data of B (blue) is calculated by use of the pixel data of, of the pixels situated around the pixel, the pixels where color filters of B (blue) is disposed.

That is, with respect to the position of the pixel indicated by the arrow X where a color filter of G (green) is disposed, the pixel data of R (blue) is, for example as shown in FIG. 8B, the average value of the pixel data of R (red) obtained from the two pixels situated above and below the pixel, and the pixel data of B (blue) is, for example as shown in FIG. 8C, the average value of the pixel data of R (red) obtained from the two pixels situated on the left and right sides of the pixel.

Moreover, for example, with respect to the position of the pixel indicated by the arrow Y where a color filter of B (blue) is disposed, as the pixel data of G (green) which is absent, for example as shown in FIG. 8D, the average value of the pixel data of, of the four pixels where color filters of G (green) are disposed and that are adjacent to the pixel, the two pixels having intermediate pixel values are adopted. Moreover, as the pixel data of R (red) which is absent, for example as shown in FIG. 8E, the average value of the pixel data of the four pixels where color filters of R (red) are disposed and that are adjacent to the pixel is adopted. The method of selecting the pixel to be the object of the average calculation is not limited to the above-described one.

In doing the above-described interpolation processing, the second image processor 61 reads out the pixel data corresponding to the pixels from the image memory 54 in accordance with the order of pixels in which the reset operation is performed.

That is, in the image memory 54, the pixel data are stored in the order of pixels in which the output operation for generating pixel signals for recoding was performed. For example, in the case shown in FIG. 7A, the pixel data of the pixels are stored in the image memory 54 in the order of the pixel “5”, the pixel “6”, . . . , the pixel “1”, . . . and the pixel “4”, and when the second image processor 61 reads out the pixel data of the pixels from the image memory 54, the pixel data are read out in order from the pixel data corresponding to the pixel “1” to the pixel data corresponding to the pixel “12”.

This is for the following reason: Since a unique processing can be performed by reading out the pixel data from the pixel “1”, the processing can be achieved by a hardware (by an ASIC), so that a significantly high-speed processing is enabled compared to an adaptive processing (program processing) in which the pixel data readout order changes according to the timing of the shutter operation.

The third image processor 62 performs, on the image data having undergone the interpolation processing by the second image processor 61, a black level correction to correct the black level to the reference black level, a white balance adjustment to perform the level conversion of the pixel data of the color components of R (red), G (green) and B (blue) based on the reference of white according to the light source, and a gamma correction to correct the gamma characteristic of the pixel data of R (red), G (green) and B (blue).

The display controller 63 transfers the pixel data of an image outputted from the image processor 26 to the VRAM 55 in order to display the image on the LCD 4. The image compressor 64 performs a predetermined compression processing according to the JPEG (joint picture experts group) method such as two-dimensional DCT (discrete cosine transform) or Huffman coding on the pixel data of the recorded image having undergone the above-mentioned various processings by the third image processor 62 to thereby generates compressed image data, and an image file comprising the compressed image data to which information on the taken image (information such as the compression rate) is added is recorded in the image storage 56.

The image storage 56 comprises a memory card or a hard disk, and stores images generated by the main controller 30. In the image storage 56, image data are recorded in a condition of being aligned in time sequence, and for each frame, a compressed image compressed according to the JPEG method is recorded together with index information on the taken image (information such as the frame number, the exposure value, the shutter speed, the compression rate, the recording date, whether the flash is on or off at the time of exposure, and scene information).

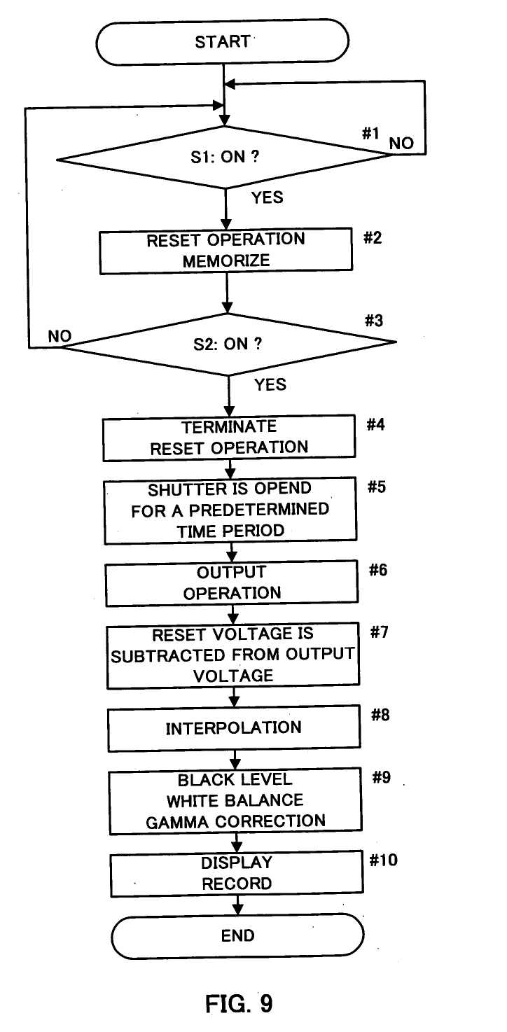

Next, a series of processings by the main controller 30 of the image capturing apparatus 1 will be described with reference to FIG. 9.

As shown in FIG. 9, when the shutter start button 4 is half depressed (YES at step #1), the image capture controller 59 causes the image sensor 19 to start the reset operation (step #2).

That is, as shown in FIGS. 6 and 7A, the image capture controller 59 causes the image sensor 19 to perform the reset operation in order from the pixel “1”, and when the reset operation of the pixel “12” is completed, causes the image sensor 19 to again perform the reset operation in order from the pixel “1”. As mentioned above, with respect to each pixel, the voltage (reset voltage) of the pixel immediately after the reset operation is stored into the image memory 54 so as to be updated. In parallel to this processing, the exposure control value determiner 58 determines the exposure control values for the exposure operation for recording based on the detection signal (the brightness of the subject) from the AE sensor 14.

While the half depression of the shutter start button 4 is continued, the image capture controller 59 causes the processings of steps #1 and #2 to be repeated (No at step #3), and when the shutter start button 4 is fully depressed (YES at step #3), causes the image sensor 19 to stop the reset operation (step #4).

This corresponds to the processing performed at the time T=T3 of FIG. 7A, and as shown in FIG. 7A, the image capture controller 59 causes the image sensor 19 to stop the reset operation even if the reset operation has not been completed up to the pixel “12” shown in FIG. 6 (even if the reset operation has been completed only up to a pixel on the way).

Then, the image capture controller 59 opens the shutter for the exposure time determined by the exposure control value determiner 58 (the period from the time T=T4 to the time T=T5 shown in FIG. 7A) (step #5), and after closing the shutter, causes the image sensor 19 to perform the charge output operation for generating pixel signals for recording (step #6, the time T=T6 shown in FIG. 7A). In that case, as mentioned above, the output operation is performed in order from the pixel next to the pixel on which the reset operation is performed last.

When the output operation is completed, the image capture controller 59 performs the processing to subtract the reset voltage of the pixels stored in the image memory 54 at step S2 from the output voltage obtained by the output operation (step #7). This is because the pixel data obtained by causing the image sensor 19 to perform the output operation for generating pixel signals for recording contains noise (the reset voltage) and it is necessary to remove the noise from the pixel data to obtain a more beautiful image.

Then, the second image processor 61 performs the interpolation processing to obtain the pixel data of the color components of R (red), G (green) and B (blue) at the positions of the pixels based on the noise-removed pixel data stored in the image memory 54 (step #8). In that case, as mentioned above, the interpolation processing is performed after the pixel data corresponding to the pixels are read out from the image memory 54 in the order of pixels in which the reset operation is performed.

Thereafter, the third image processor 62 performs the black level correction, the white balance adjustment and the gamma correction on the image data having undergone the interpolation processing by the second image processor 61 (step #9), the display controller 63 performs, in order to display an image outputted from the third image processor 62 on the LCD 4, a processing such as the conversion of the resolution of the image and displays the image on the LCD 4 as an after view, and the image compressor 64 performs a predetermined compression processing on the pixel data of the recorded image having undergone the above-mentioned various processings by the third image processor 62 and records the compressed image data into the image storage 56 (step #10).

As described above, since when the shutter start button 4 is half depressed, the image sensor 19 is caused to perform the reset operation of the pixels in order and when the shutter start button 4 is fully depressed, the image sensor 19 is caused to stop the reset operation at that point of time and starts the output operation for generating pixel signals for recording from the pixel next to the pixel on which the reset operation is performed last before the shutter start button 4 is fully depressed, the shutter release time lag can be reduced compared to the conventional structure.

By this, an image as close to the subject image at the point of time when the user fully depresses the shutter start button 4 (the capturing timing intended by the user) as possible can be obtained compared to the conventional structure in which when the shutter start button 4 is fully depressed, after the reset operations of all the pixels are performed, the output operation for generating pixel signals for recording is performed. Since the time required for the reset operation of the image sensor 19 increases as the number of pixels of the image sensor 19 increases, the effect is conspicuous particularly when a high resolution image sensor 19 is used.

Moreover, according to the present embodiment, since the reset voltage immediately after the reset operation is stored in the image memory 54 so as to be updated with respect to each pixel, noise can be removed from the pixel data obtained by the output operation for generating pixel signals for recording performed after the shutter start button 4 is fully depressed, so that a beautiful taken image can be generated.

Further, since when the shutter start button 4 is fully depressed, the shutter is opened and the pixels are caused to simultaneously start the exposure operation, an image with no or little sense of difference which image is close to the subject image intended by the user can be taken compared to the prior art in which there is a difference in the start time of the exposure operation among the pixels.

Moreover, since in performing the above-described interpolation processing, the pixel data corresponding to the pixels are read out from the image memory 54 in the order of pixels in which the reset operation is performed, the speed of the image processing can be enhanced.

Hereinafter, modifications of the present embodiment will be described.

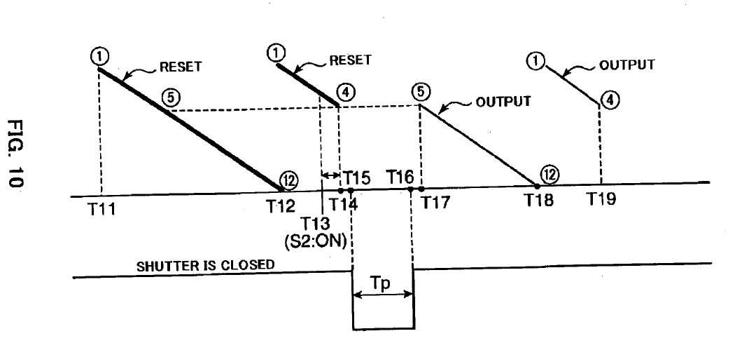

(1) While in the above-described embodiment, the digital camera 1 is provided with a diaphragm and a shutter (focal plane shutter) and the aperture value of the diaphragm is fixed, when the exposure value of the image sensor 19 is controlled by controlling the aperture value, the pixels of the image sensor 19 can be operated in the following manner. The operation of the pixels of the image sensor 19 in the present modification will be described with reference to FIG. 10.

In this modification, the aperture value is set as the control parameter of the exposure value of the image sensor 19, and when the shutter start button 4 is fully depressed, the reset operation is performed until the operation of the diaphragm is completed.

That is, as shown in FIG. 10, when the shutter start button 4 is half depressed at the time T=T11, the image capture controller 59 starts the reset operation of the pixels of the image sensor 19. This reset operation is repeated in the above-mentioned order until the shutter start button 4 is fully depressed.

Then, as shown in FIG. 10, when the shutter start button 4 is fully depressed at the time T=T13, the image capture controller 59 causes the diaphragm to operate so that a preset aperture value is reached and causes the reset operation to be performed until the operation of the diaphragm is completed at the time T=T14.

Then, when the operation of the diaphragm is completed at the time T=T14, the image capture controller 59 stops the execution of the reset operation at the pixel the reset operation of which is completed at that point of time and opens the shutter based on the exposure control values determined by the exposure control value determiner 58, and after the shutter is closed, causes the output operation for generating pixel signals for recording to be performed from the pixel next to the pixel on which the reset operation is performed last like in the first embodiment (the time T=T17).

The time until which the reset operation is continued is not limited to the time of completion of the operation of the diaphragm; the reset operation may be continued until the completion of the image capturing preparation operation even if the shutter start button 4 is fully depressed.

(2) While in the description given above, a digital camera of a single lens reflex (SLR) type is described as an example of the image capturing apparatus, this modification is a digital camera other than the SLR type (what is generally called a compact camera).

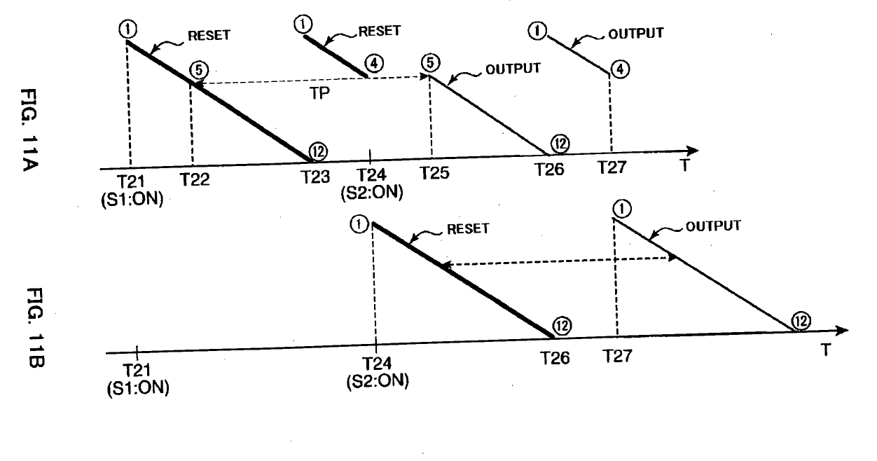

A digital camera of this type will be described below, and as the mechanical structure of this type of digital camera, for example, one is adoptable that is disclosed in Patent Application Publication No. US 2003/0210343A1, and a detailed description of the structure is omitted. The operation of the pixels of the image sensor 19 in a case where the image capturing apparatus 1 has no shutter mechanism and the aperture value is fixed, that is, in a case where the exposure value of the image sensor 19 is determined only with a so-called electronic shutter will be described with reference to FIG. 11A.

As shown in FIG. 11A, this modification is substantially similar to the first embodiment in that when the shutter start button 4 is half depressed, the image sensor 19 is caused to start the reset operation of the pixels in order and that when the shutter start button 4 is fully depressed, the reset operation of the image sensor 19 is stopped at that point of time and the output operation for generating pixel signals for recording is started from the pixel next to the pixel the reset operation of which is completed at that stop time. On the other hand, this modification is different from the embodiment in that with respect to each pixel, the output operation for generating pixel signals for recording is performed at the point of time when the exposure time determined by the exposure control value determiner 58 has elapsed from the time when the last reset operation is performed.

That is, as shown in FIG. 11A, assuming that the exposure time determined by the exposure control value determiner 58 is Tp and the reset operation of the pixel “4” is completed, for example, at the point of time when the shutter start button 4 is fully depressed, the output operation for generating pixel signals for recording by the pixel “5” is performed at the time T=T22+Tp (=T25) when the exposure time TP has elapsed from the time T=T22 at which the last reset operation is performed with respect to the pixel “5”.

Moreover, the output operation for generating pixel signals for recording by the pixel “4” is performed at the time T=T24+Tp (=T27) when the exposure time Tp has elapsed from the time T=T24 at which the last reset operation is performed with respect to the pixel “4”.

In this case, although the time to start the exposure control varies among the pixels (a time difference is caused), compared to the conventional case where all the pixels perform the reset operation when the shutter start button 4 is fully depressed as shown in FIG. 11B, the exposure period of the pixels is close to the time when the shutter start button 4 is fully depressed, so that an image as close to the subject image at the point of time when the user fully depresses the shutter start button 4 (the capturing timing intended by the user) as possible can be obtained.

In FIG. 11A, since a case is assumed where the exposure time Tp is longer than the period of the reset operation (the -time required for all the pixels to complete one reset operation), the output operation for generating pixel signals for recording by the image sensor 19 is shown as being started after a predetermined time has elapsed from the timing of the full depression of the shutter start button 4, the time difference between the timing of the start of the output operation for generating pixel signals for recording by the image sensor 19 and the timing of the full depression of the shutter start button 4 varies according to the length of the set exposure period Tp.

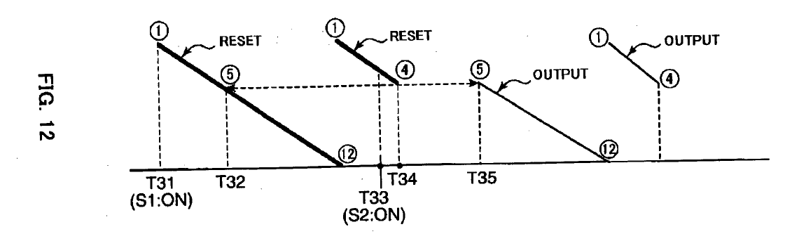

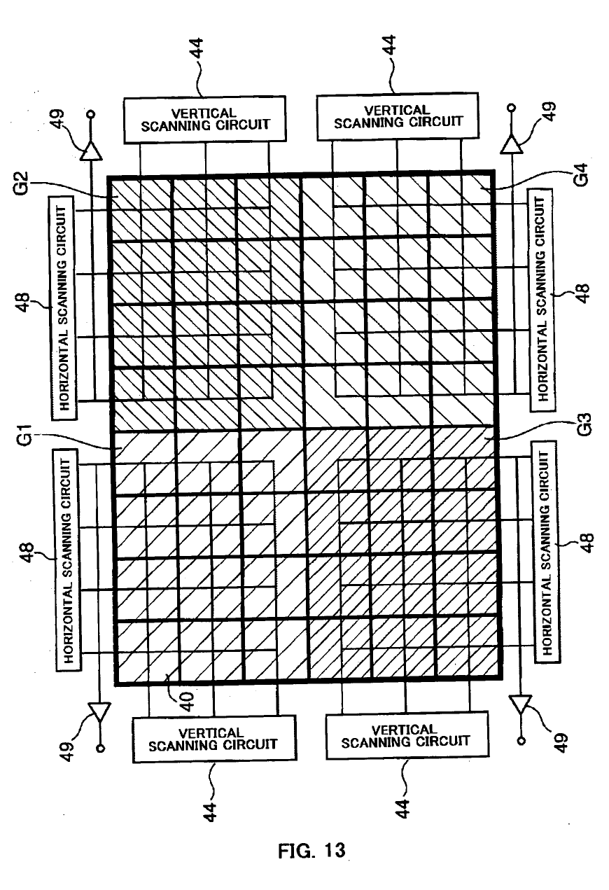

(3) While in the above-described modification of (2), the exposure value of the image sensor 19 is determined only with a so-called electronic shutter, a modification in which the aperture value is set as the control parameter of the exposure value of the image sensor 19 and like in the above-described modification of (1), the reset operation is caused to be performed until the operation of the diaphragm is completed even if the shutter start button is fully depressed will be described with reference to FIG. 12.

As shown in FIG. 12, when the shutter start button 4 is half depressed at the time T=T31, the image capture controller 59 causes the image sensor 19 to start the reset operation of the pixels in order. Then, when the shutter start button 4 is fully depressed at the time T=T33, the diaphragm is set at the aperture value determined by the exposure control value determiner 58, and the image sensor 19 is caused to continuously perform the reset operation until the time T=T34 at which the operation of the diaphragm is completed. A description of the output operation for generating pixel signals for recording is omitted because it is substantially similar to that of the modification of (2). The time until which the reset operation is continued is not limited to the time of completion of the operation of the diaphragm; the reset operation may be continued until the completion of the exposure preparation operation even if the shutter start button 4 is fully depressed.

As described above, with respect to the stop timing of the reset operation, irrespective of whether the digital camera is the single lens reflex type or not, when the digital camera determines the exposure value of the image sensor 19 only with an electronic shutter (when the digital camera is provided with neither a shutter nor a diaphragm), the reset operation of the image sensor 19 is stopped at the point of time when the shutter start button 4 is fully depressed.

Moreover, when the exposure value of the image sensor 19 is controlled only with the shutter speed (the aperture value is fixed), the reset operation of the image sensor 19 is also stopped at the point of time when the shutter start button 4 is fully depressed.

Further, when the exposure value of the image sensor 19 is controlled only with the aperture value and when it is controlled with both the shutter speed and the aperture value, the reset operation of the image sensor 19 may be stopped either at the point of time when the shutter start button 4 is fully depressed or at the point of time when the operation of the diaphragm is completed.

Moreover, the time until which the reset operation is continued is not limited to the time of completion of the operation of the diaphragm; the reset operation may be continued until the completion of the exposure preparation operation even if the shutter start button 4 is fully depressed.

(4) While in the above-described embodiment and modifications, the order in which a series of signals are read out is set with respect to all the pixels (effective pixels) of the image sensor 19; the following may be performed: The pixels of the image sensor 19 are divided into a plurality of groups, the order of pixels in which the reset operation and the output operation for generating pixel signals for recording are performed is set in each group, and the reset operation and the output operation for generating pixel signals for recording are performed in parallel among the groups in this order. By this, the time required for reading out the pixel signals from the pixels of the image sensor 19 can be further reduced.

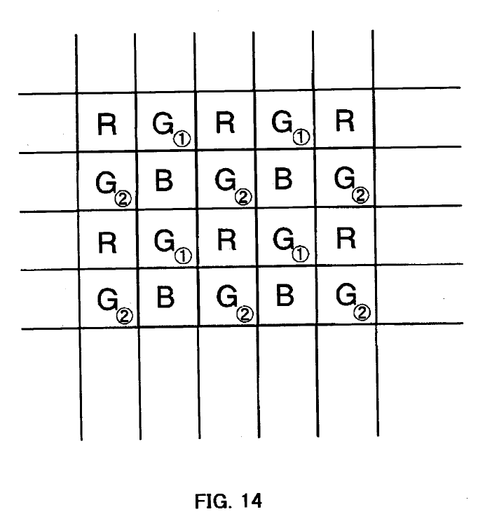

That is, in this modification, for example as shown in FIG. 13, the image sensing area of the image sensor 19 is divided into four parts to divide the pixels into a plurality of groups G1 to G4, and the vertical scanning circuit 44 and the horizontal scanning circuit 48 are provided in each of the groups G1 to G4. In FIG. 13, the image sensor 19 has 48 pixels (effective pixels) arranged in six rows and eight columns, and the image sensing area constituted by these pixels is divided into two in the vertical and horizontal directions to form the groups G1 to G4 constituted by 12 pixels arranged in three rows and four columns.

Although not shown in FIG. 13, signal lines electrically connecting the image sensor 19, the sampler 51, the A/D converter 52 and the image memory 54 are provided so as to correspond to the groups G1 to G4 (in this case, four signal lines are provided for each group).

According to this structure, since the reset operation and the output operation for generating pixel signals for recording can be performed in parallel among the groups G1 to G4, the time required for reading out the pixel signals from the pixels of the image sensor 19 can be reduced compared to the case where the order in which a series of signals are read out is set with respect to all the pixels (effective pixels) of the image sensor 19.

When the pixels of the image sensor 19 are grouped like this, in each group, the reset operation of the pixels and the output operation for generating pixel signals for recording are caused to be performed like in the above-described embodiment and modifications.

In grouping the pixels, instead of grouping the pixels of the image sensor 19 by dividing the image sensing area as described above, the pixels may be grouped, for example, according to the kind of the color filter.

In the case of the image sensor 19 of the Bayer arrangement in which color filters of, for example, R (red), G (green) and B (blue) having different spectral characteristics are disposed at a ratio of 1:2:1, for example, the pixels where the color filters of B (blue) are disposed and the pixels where the color filters of R (red) are disposed constitute one group and the pixels where the color filters of G (green) are disposed constitute one group, whereby the pixels can be divided into a total of two groups.

Alternatively, as shown in FIG. 14, the pixels where the color filters of G (green) are disposed may be divided into two groups, a group of the pixels denoted by “1” and a group of the pixels denoted by “2”, so that the pixels of the image sensor 19 are divided into a total of four groups together with a group of the pixels where the color filters of B (blue) are disposed and a group of the pixels where the color filters of R (red) are disposed.

(5) While in the above-described main embodiment, the signals obtained by the reset operation are used for removing noise from the pixel data for recording, in a digital camera which is not SLR type, the following can be performed in addition thereto: A live view image is generated by use of the charges obtained by the reset operation and the image is displayed on the image display portion (LCD, etc.) until the shutter start button is fully depressed.

The live view image is an image captured by the image sensor 19 which image is displayed on the image display portion so as to change in a predetermined cycle (for example, 1/30 second) until an image of the subject is directed to be recorded. By the live view image, the condition of the subject is displayed on the image display portion substantially in real time, and the user can confirm the condition of the subject on the image display portion.

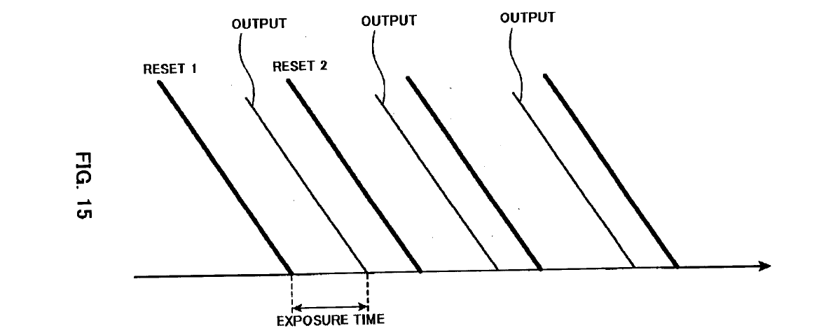

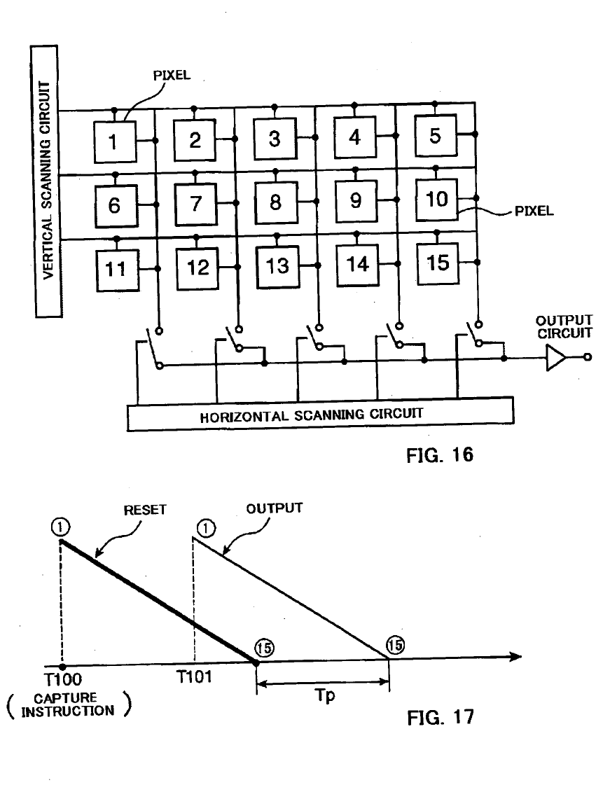

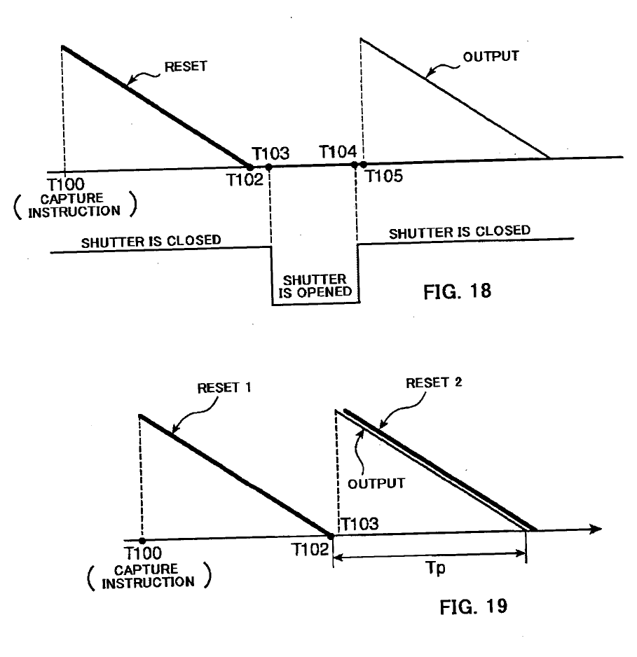

(6) As a driving control of the image sensor 19 for generating and displaying the live view image, a modification shown in FIG. 15 is adoptable as well as the above-described modification of (5).

The “output” operation in FIG. 15 indicates an operation to output pixel signals for live view image generation. As shown in FIG. 15, in the present embodiment, the charges obtained from the pixels by the reset operation are not used for generating the live view image, and the operation to output pixel signals for live view image generation is separately performed for generating the live view image.

That is, in this modification, during the exposure preparation period (the period from the half depression of the shutter start button to before the full depression thereof), the reset operation and the operation to output pixel signals for live view image generation are caused to be alternately performed such that with respect to each pixel, the image sensor 19 is caused to perform the reset operation of the pixels and then, perform the operation to output pixel signals for live view image generation after a predetermined exposure time has elapsed since the reset operation. Thus, the reset operation in this modification is merely an operation to discharge the charges accumulated at the pixels of the image sensor 19.

In the operation to output pixel signals for live view image generation, by performing a so-called pixel thinning-out readout processing of selecting some of the pixels of the image sensor 19 and causing the selected pixels to perform the output operation, and generating the live view image by use of the charges obtained by the output operation, the display cycle of the live view image can be prevented or restraint from being prolonged. As the selection of the pixels, various selections such as selecting every other pixel row in the vertical direction is adoptable.

Moreover, since the reset operation in this modification is merely an operation to discharge the charges accumulated at the pixels of the image sensor 19 and this operation can be simultaneously performed at a predetermined number of pixels as mentioned above, in this example, the reset operations of the predetermined number of pixels are simultaneously performed to prevent or restrain the display cycle of the live view image from being prolonged. That the inclination of the straight lines representative of the reset operation and the operation to output pixel signals for live view image generation in FIG. 15 is larger than that of the straight lines representative of the reset operation, etc. in FIG. 7, etc. indicates that by performing such a reset operation and the above-mentioned thinning-out readout processing, the signal readout time is shorter than that when the operation to read out the pixel signals one by one from all the effective pixels is performed.

(7) It is to be noted that the above described structures are applicable not only to the above-described digital camera but also to mobile telephones provided with an image capturing optical system and the CMOS image sensor 19.

Moreover, the above described structures are not only adoptable to mobile telephones but is also widely adoptable to other apparatuses, for example, portable communication apparatuses provided with a communication portion performing data transmission and reception with other communication apparatuses such as digital video cameras, PDAs (personal digital assistants), personal computers and mobile computers.

(8) The image sensor is not limited to the CMOS image sensor, but a MOS image sensor is also adoptable.

As described above, the above-described image capturing apparatus is provided with: the image sensor comprising a plurality of pixels aligned in two intersecting directions; the image capture controller that causes the image sensor to perform the exposure operation, specifies a given pixel from among the plurality of pixels, and causes the specified pixel to output a pixel signal; and the input operation portion for inputting an instruction to cause the image sensor to generate the pixel signal for recording to be recorded in a predetermined recording portion.

Until the instruction to generate the pixel signal for recording is inputted, the image capture controller causes the image sensor to repeat the reset operation of the pixels in a predetermined order and when the generation instruction is inputted through the input operation portion, the image capture controller causes the image sensor to stop the reset operation irrespective of a position of the order of the pixel the reset operation of which is completed, in order words, irrespective of up to which pixel the reset operation is completed.

By this, the exposure operation for obtaining the pixel signal for recording by the image sensor can be performed at a timing close to the timing of the generation instruction compared to the prior art in which after the instruction to generate the pixel signal for recording is inputted through the input operation portion, the image sensor is caused to perform the reset operations of all the pixels.

In the above-described image capturing apparatus, when the exposure period for generating the pixel signal for recording has elapsed, the image capture controller causes the image sensor to start the output operation for generating the pixel signal for recording. This output operation is performed in accordance with a time order corresponding to the predetermined order with the pixel next to the pixel on which the reset operation is performed last as the first pixel. The output operation is completed at the pixel on which the reset operation is performed last.

Moreover, one of the above-described image capturing apparatus is provided with: the shutter for performing the operation to intercept light directed to the image sensor; and the shutter controller that controls the intercepting operation of the shutter. After the control to stop the reset operation by the image capture controller, the shutter controller opens the shutter for a time corresponding to the exposure period so that the image sensor is exposed.

That is, since the shutter is provided, an appropriate image can be obtained by causing the exposure operation for obtaining the pixel signal for recording to be substantially simultaneously performed with respect to each pixel of the image sensor.

Moreover, one of the above-described image capturing apparatus is provided with: a diaphragm for adjusting a quantity of light directed to the image sensor; and a diaphragm controller that controls an aperture. When the aperture (aperture value) is included as a parameter determining an exposure value of the image sensor, even if the generation instruction is inputted through the input operation portion, the image capture controller causes the reset operation of the image sensor to be continuously performed until an operation to change the aperture is completed.

Moreover, one of the above-described image capturing apparatus is provided with: a storage that stores the pixel signals outputted from the image sensor by the reset operation and the output operation for generating the pixel signal for recording; and a calculator that reads out the pixel signals from the storage and removes noise by subtracting a voltage of the pixel after the reset operation from a voltage corresponding to the pixel signal outputted from the image sensor by the output operation for generating the pixel signal for recording. By this, a beautiful image can be obtained.

Moreover, when reading out the pixel signals from the storage, the calculator reads out the pixel signals in order from a pixel signal of a pixel on which the reset operation is performed first.

Consequently, since a unique processing can be performed when a predetermined processing is performed on the pixel signals after the pixel signals are read out, the processing can be made hardware (made an ASIC), so that a significantly high-speed processing is enabled compared to an adaptive processing (program processing) in which the pixel data readout order changes according to the timing of the instruction to generates the pixel signal for recording.

Moreover, in one of the above-described image capturing apparatus, the pixels of the image sensor are divided into a plurality of groups, and until an instruction to generate the pixel signal for recording is provided through the input operation portion, the image capture controller causes the reset operation by the pixels to be repetitively performed in a predetermined order in each group, and when the instruction to generate the pixel signal for recording is provided through the input operation portion, the image capture controller causes the reset operation to be stopped irrespective of an order of a pixel the reset operation of which is completed in each group.

Consequently, the pixel signal of each pixel of the image sensor can be read out in a short time (at high speed)

Moreover, the image sensor is divided into groups according to an image sensing area thereof.

Moreover, in the image sensor, color filters of a plurality of colors are disposed at the pixels, and the pixels are divided into groups according to a kind of the color filter disposed thereat.

Moreover, a portable communication apparatus can be structured by providing the above-described image capturing apparatus; and a communication portion that transmits and receives a signal including an image signal obtained by the image capturing apparatus, to and from an external apparatus.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image capturing apparatus comprising:
an image sensor comprising a plurality of pixels aligned in two intersecting directions;
an image capture controller that causes the image sensor to perform an exposure operation, specifies a given pixel from among the plurality of pixels, and causes the specified pixel to output a pixel signal; and
an input operation portion for inputting an instruction to cause the image sensor to generate a pixel signal for recording to be recorded in a predetermined recording portion,
wherein until the instruction to generate the pixel signal for recording is inputted, the image capture controller causes the image sensor to repeat a reset operation of the pixels in a predetermined order and when the generation instruction is inputted through the input operation portion, the image capture controller causes the image sensor to stop the reset operation irrespective of a position of the pixel the reset operation of which is completed.

2. An image capturing apparatus according to claim 1,
wherein when an exposure period for generating the pixel signal for recording has elapsed, the image capture controller causes the image sensor to start an output operation for generating the pixel signal for recording, and
wherein the output operation for generating the pixel signal for recording is performed in accordance with a time order of the reset operation corresponding to the predetermined order starting from a pixel next to a pixel on which the reset operation is performed last, and the output operation is completed at a pixel on which the reset operation is performed last.

3. An image capturing apparatus according to claim 2 further comprising:
a shutter for performing an operation to intercept light directed to the image sensor; and
a shutter controller that controls the intercepting operation of the shutter,
wherein after the control to stop the reset operation by the image capture controller, the shutter controller opens the shutter for a time corresponding to the exposure period so that the image sensor is exposed.

4. An image capturing apparatus according to claim 1 further comprising:
a diaphragm for adjusting a quantity of light directed to the image sensor; and
a diaphragm controller that controls an aperture,
wherein when the aperture is included as a parameter determining an exposure value of the image sensor, even if the generation instruction is inputted through the input operation portion, the image capture controller causes the image sensor to perform the reset operation until an operation to change the aperture is completed.

5. An image capturing apparatus according to claim 2 further comprising:
a storage that stores the pixel signals outputted from the image sensor by the reset operation and the output operation for generating the pixel signal for recording; and
a calculator that reads out the pixel signals from the storage and removes noise by subtracting a voltage of the pixel after the reset operation from a voltage corresponding to the pixel signal outputted from the image sensor by the output operation for generating the pixel signal for recording.

6. An image capturing apparatus according to claim 5,
wherein when reading out the pixel signals from the storage, the calculator reads out the pixel signals in order from a pixel signal of a pixel on which the reset operation is performed first.

7. An image capturing apparatus according to claim 1,
wherein the pixels of the image sensor are divided into a plurality of groups, and
wherein until an instruction to generate the pixel signal for recording is provided, the image capture controller causes the reset operation by the pixels to be repetitively performed in a predetermined order in each group, and when the instruction to generate the pixel signal for recording is provided through the input operation portion, the image capture controller causes the image sensor to stop the reset operation irrespective of a position of a pixel the reset operation of which is completed in each group.

8. An image capturing apparatus according to claim 7,
wherein the image sensor is divided into groups according to an image sensing area thereof.

9. An image capturing apparatus according to claim 7,
wherein in the image sensor, color filters of a plurality of colors are disposed one color at each pixel, and the pixels of the image sensor are divided into groups according to a kind of the color filter disposed thereat.

10. A portable communication apparatus comprising:
an image capturing apparatus; and
a communication portion that transmits and receives a signal including an image signal obtained by the image capturing apparatus, to and from an external apparatus,
wherein said image capturing apparatus comprises:
an image sensor comprising a plurality of pixels aligned in two intersecting directions;
an image capture controller that causes the image sensor to perform an exposure operation, specifies a given pixel from among the plurality of pixels, and causes the specified pixel to output a pixel signal; and
an input operation portion for inputting an instruction to cause the image sensor to generate a pixel signal for recording to be recorded in a predetermined recording portion,
wherein until the instruction to generate the pixel signal for recording is inputted, the image capture controller causes the image sensor to repeat a reset operation of the pixels in a predetermined order and when the generation instruction is inputted through the input operation portion, the image capture controller causes the image sensor to stop the reset operation irrespective of a position of the pixel the reset operation of which is completed.

11. A portable communication apparatus according to claim 10,
wherein when an exposure period for generating the pixel signal for recording has elapsed, the image capture controller causes the image sensor to start an output operation for generating the pixel signal for recording, and
wherein the output operation for generating the pixel signal for recording is performed in accordance with a time order of the reset operation corresponding to the predetermined order starting from a pixel next to a pixel on which the reset operation is performed last, and the output operation is completed at a pixel on which the reset operation is performed last.

12. A portable communication apparatus according to claim 11 further comprising:
a shutter for performing an operation to intercept light directed to the image sensor; and
a shutter controller that controls the intercepting operation of the shutter,
wherein after the control to stop the reset operation by the image capture controller, the shutter controller opens the shutter for a time corresponding to the exposure period so that the image sensor is exposed.

13. A portable communication apparatus according to claim 10 further comprising:
a diaphragm for adjusting a quantity of light directed to the image sensor; and
a diaphragm controller that controls an aperture,
wherein when the aperture is included as a parameter determining an exposure value of the image sensor, even if the generation instruction is inputted through the input operation portion, the image capture controller causes the image sensor to perform the reset operation until an operation to change the aperture is completed.

14. A portable communication apparatus according to claim 11 further comprising:
a storage that stores the pixel signals outputted from the image sensor by the reset operation and the output operation for generating the pixel signal for recording; and
a calculator that reads out the pixel signals from the storage and removes noise by subtracting a voltage of the pixel after the reset operation from a voltage corresponding to the pixel signal outputted from the image sensor by the output operation for generating the pixel signal for recording.

15. A portable communication apparatus according to claim 14,
wherein when reading out the pixel signals from the storage, the calculator reads out the pixel signals in order from a pixel signal of a pixel on which the reset operation is performed first.

16. A portable communication apparatus according to claim 10,
wherein the pixels of the image sensor are divided into a plurality of groups, and
wherein until an instruction to generate the pixel signal for recording is provided, the image capture controller causes the reset operation by the pixels to be repetitively performed in a predetermined order in each group, and when the instruction to generate the pixel signal for recording is provided through the input operation portion, the image capture controller causes the image sensor to stop the reset operation irrespective of a position of a pixel the reset operation of which is completed in each group.

17. A portable communication apparatus according to claim 16,
wherein the image sensor is divided into groups according to an image sensing area thereof.

18. A portable communication apparatus according to claim 16,
wherein in the image sensor, color filters of a plurality of colors are disposed one color at each pixel, and the pixels of the image sensor are divided into groups according to a kind of the color filter disposed thereat.
